(19) United States
(12) Patent Application Publication
(10) Pub. No.: US 2009/0289435 A1
(43) Pub. Date: Nov. 26, 2009

(54) Composite Bicycle Frame

(75) Inventors: Ming-Jhe Wu, Yuchih Township (TW); Owen Chang, Dajia Township (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: GIANT MANUFACTURING CO., LTD., Taichung Hsien (TW)

(21) Appl. No.: 12/210,401

(22) Filed: Sep. 15, 2008

(30) Foreign Application Priority Data
May 22, 2008 (TW) 97118941

(51) Int. Cl. B62K 19/02

(52) U.S. Cl. 280/281.1

(57) ABSTRACT

A composite bicycle frame includes a plurality of tubes. The tubes includes a seat tube, a main tube and chain stays. The main tube is made of metallic materials. The seat tube and the chain stays are made of resin fiber materials.

### RELATED APPLICATIONS

The application claims priority to Taiwan Application Serial Number 97118941, filed May 22, 2008, which is herein incorporated by reference.

### BACKGROUND

1. Field of the Invention

The present invention relates to bicycle techniques. More particularly, the present invention relates to a composite bicycle frame that is made of different materials.

2. Description of Related Art

Bicycle frame designs are directly related to comfort and safety when a rider is riding on a bicycle. When considering both the manufacturing costs and improvements to comfort and safety for riding, many companies or businesses have continuously invested a lot of resources to develop and research new bicycle frames. Thus, many approaches have been announced or developed to address the problems of the bicycle frame or improve the designs of the bicycle frame.

One of these developed approaches of designing the bicycle frames is to modify or change the materials of the bicycle frames. The bicycle frame in accordance with prior art generally use fiber material, metallic material (such as aluminum alloy), etc. The fiber material is light, stiff, etc. However, the fiber material is expensive, brittle, and easily being fragmented or broken by impacts or collisions (such as the front wheel runs over road bumps) during riding, which incurs safety problems for riding. The metallic material (such as aluminum alloy) provides good malleability and flexibility for the frame, and is cheaper than the fiber material. However, the metallic material adds weight to the frame and cannot provide a lightweight design for the frame.

Therefore, composite frames with both the fiber material and metallic material (such as aluminum alloy) have been developed. For example, U.S. Pat. No. 6,994,367 disclosed a composite bicycle frame with two different materials. However, the distribution of the fiber tubes and the aluminum alloy tubes of the composite frame disclosed by the aforementioned patent cannot amplify the features of the combination of the two materials. Thus, the entire frame cannot be lightened, and the price of the frame cannot be lowered.

Therefore, there is a need to provide an improved composite bicycle frame to mitigate or obviate the aforementioned problems.

### SUMMARY

An object of the present invention is to provide a composite bicycle frame to eliminate or address the problems of the bicycle frame in accordance with the prior art that cannot lower manufacturing costs or improve riding comfort.

A composite bicycle frame comprises a plurality of tubes comprising a seat tube, a main tube and chain stays, wherein the main tube is made of metallic material, and the seat tube and the chain stays are made of fiber material.

A composite bicycle frame comprises a top tube, a seat tube, a head tube, a bottom bracket, a main tube and chain stays and seat stays. The top tube has a first end and a second end. The seat tube is connected to the first end of the top tube, and has a bottom end, a length and a fiber segment, and the fiber segment has a length longer than a half of the length of the seat tube. The head tube is connected to the second end of the top tube. The bottom bracket is connected to the bottom end of the seat tube. The main tube is connected to the head tube and the bottom bracket, has a length and a metal segment, and the metal segment has a length longer than a half of the length of the main tube. The chain stays are connected to the seat tube and the bottom bracket, have a length and a fiber segment, and the fiber segment has a length longer than a half of the length of the chain stays. The seat stays are connected to the chain stays and the seat tube.

The fiber material may use carbon fiber. The metallic material may use aluminum alloy.

Applications of the present invention can achieve the effects as follows.

The composite bicycle frame increases structure proportion of carbon fiber, and critical components of the frame structure are made of metallic material, such as aluminum alloy so as to provide excellent stiffness for the frame. Thus, the risks of fracture or split of the main tube caused by impacts of the front wheels can be reduced. The main tube can cooperate with the head tube and the bottom bracket to have an optimized structure design to improve entire frame rigidity and stiffness of stamping during riding.

The seat tube, the chain stays, the seat stays and the top tube can be jointed and shaped integrally with carbon fiber, which provides a frame with enhanced lightweight designs and optimized comforts designs.

The composite bicycle frame is lighter than a conventional aluminum alloy frame, and has higher stiffness and cheaper than a conventional carbon fiber frame.

### BRIEF DESCRIPTION OF THE DRAWINGS

These and other features, aspects, and advantages of the present invention will become better understood with regard to the following description, appended claims, and accompanying drawings where:

FIG. 1 is a perspective view of an embodiment of a composite bicycle frame;

FIG. 2 is side view of a bicycle comprising the composite bicycle frame in FIG. 1;

FIG. 3 is a bottom view of chain stays of the composite bicycle frame in FIG. 1;

FIG. 4 is an enlarged side view of a bottom bracket of a second embodiment of the composite bicycle frame; and

FIG. 5 is a bottom view of chain stays of the composite bicycle frame in FIG. 4.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

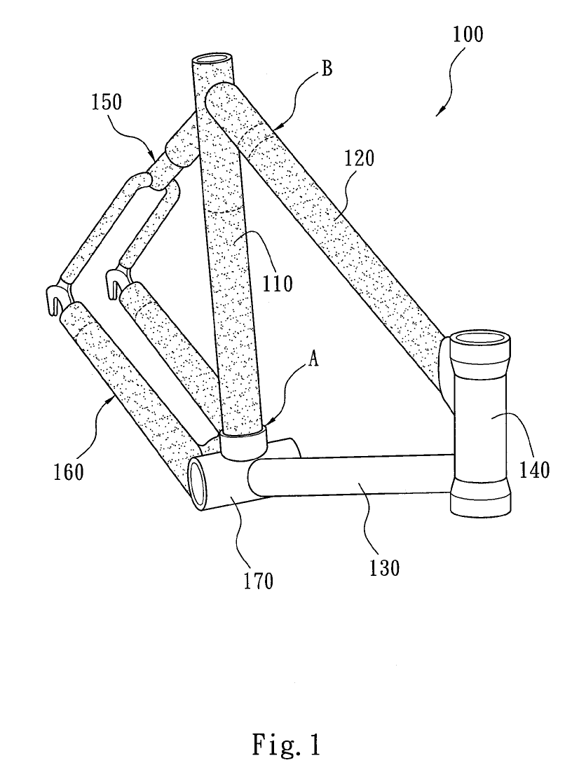

Refer to FIG. 1. An embodiment of a composite bicycle frame 100 comprises a plurality of tubes. The tubes comprise a seat tube 110, a top tube 120, a main tube 130, a head tube 140, seat stays 150, chain stays 160 and a bottom bracket 170. The tubes of the composite bicycle frame 100 are respectively made of fiber material and metallic material. In the embodiment, the fiber material is carbon fiber, and the metallic material is aluminum alloy.

In the embodiment, the seat tube 110 connects to a first end of the top tube 120. The head tube 140 connects to a second end of the top tube 120. The bottom bracket 170 is connected to the bottom end of the seat tube 110. The main tube 130 connects to the head tube 140 and the bottom bracket 170. The seat stays 150 connect to the seat tube 110. The chain stays 160 are connected to the seat stays 150 and the bottom bracket 170. The seat tube 110, the top tube 120, the seat stays 150 and the chain stays 160 are made of carbon fiber. The head tube 140, the main tube 130 and the bottom bracket 170 are made of aluminum alloy. In other embodiments, the head tube 140 and the bottom bracket 170 may be made of carbon fiber.

The whole seat tube 110 may be made of fiber material. Alternatively, the seat tube 110 may have a segment made of fiber material, and the segment is called fiber segment as illustrated by the stippling on the seat tube 110 in FIG. 1. The fiber segment may have a length longer than a half of the total length of the seat tube 110, and is made of carbon fiber.

The whole main tube 130 may be made of metallic material. Alternatively, the main tube 130 may have a segment made of metallic material, and the segment is called metal segment. The metal segment may have a length longer than a half of the total length of the main tube 130, and is made of aluminum alloy.

The whole chain stays 160 may be made of fiber material. Alternatively, the chain stays 160 may have a segment made of fiber material, and the segment is called fiber segment. The fiber segment may have a length longer than a half of the total length of the chain stays 160, and is made of carbon fiber.

The joints between the tubes may adopt tube insertion joints, or seamless joints. For example, the joint between the seat tube 110 and the bottom bracket 170 adopts a tube insertion joint, i.e. an end of the seat tube 110 (an inside tube) is inserted and held in the bottom bracket 170 (an outside tube) as denoted by “A” in FIG. 1. The joint between the top tube 120 and the seat tube 110 adopts a seamless joint. The seamless joint is formed by a caulking treatment and a surface treatment after the two tubes are connected to each other, as denoted by “B” in FIG. 1. The caulking treatment and the surface treatment eliminate gaps at the joint of the tubes to enhance aesthetic feeling and modeling applications of the entire composite frame 100.

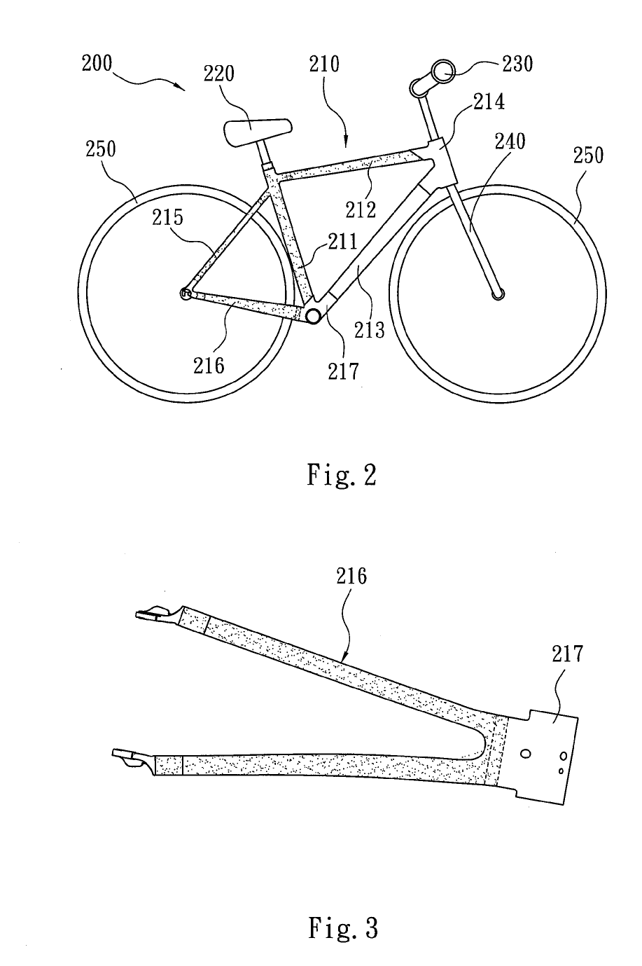

Refer to FIG. 2 and FIG. 3. An embodiment of a bicycle 200 comprises a composite bicycle frame 210, a seat 220, a handle 230, a front fork 240 and two wheels 250.

The composite bicycle frame 210 uses the composite bicycle frame 100 as previously described. The tubes of the composite bicycle frame 210 are respectively made of fiber material and metallic material. In the embodiment, the fiber material is carbon fiber, and the metallic material is aluminum alloy.

In the embodiment, the composite bicycle frame 210 comprises a seat tube 211, a top tube 212, a main tube 213, a head tube 214, seat stays 215, chain stays 216 and a bottom bracket 217. The seat tube 211, the top tube 212, the seat stays 215 and the chain stays 216 are made of carbon fiber. The head tube 214, the main tube 213 and the bottom bracket 217 are made of aluminum alloy. The chain stays 216 are connected to the bottom bracket 217 with a seamless joint.

The whole seat tube 211 may be made of fiber material. Alternatively, the seat tube 211 may have a segment made of fiber material, and the segment is called fiber segment. The fiber segment may have a length longer than a half of the total length of the seat tube 211, and is made of carbon fiber.

The whole main tube 213 may be made of metallic material. Alternatively, the main tube 213 may have a segment made of metallic material, and the segment is called metal segment. The metal segment may have a length longer than a half of the total length of the main tube 213, and is made of aluminum alloy.

The whole chain stays 216 may be made of fiber material. Alternatively, the chain stays 216 may have a segment made of fiber material, and the segment is called fiber segment. The fiber segment may have a length longer than a half of the total length of the chain stays 216, and is made of carbon fiber.

The seat 220 is mounted on the seat tube 211. The front fork 240 is mounted on the head tube 214. The handle 230 is mounted on the top of the front fork 240. The wheels are respectively mounted on the front fork 240, and the joint between the seat stays 215 and the chain stays 216.

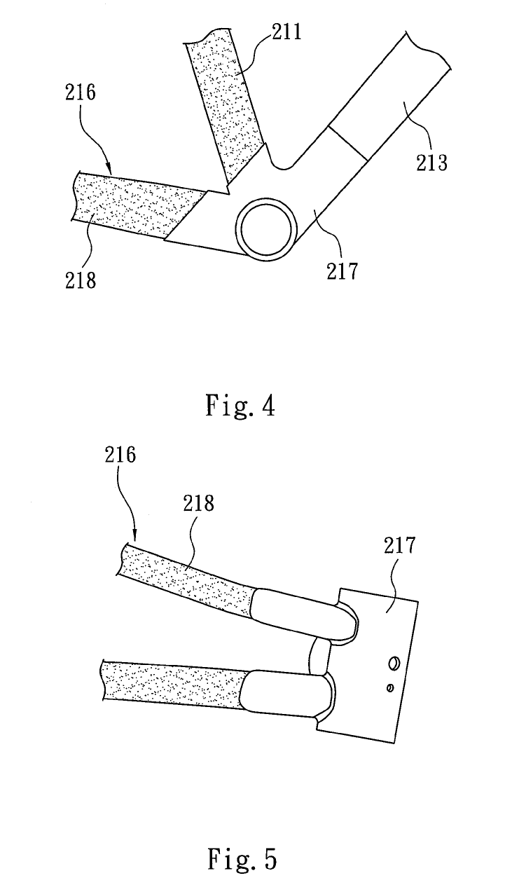

Refer to FIG. 4 and FIG. 5. Another embodiment of the present invention modifies the chain stays 216. The chain stays 216 comprise two forking tubes 218. Each of the forking tubes 218 is connected to the bottom bracket 217 with the tube insertion joints.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A composite bicycle frame comprising:
a plurality of tubes comprising a seat tube, a main tube and chain stays, wherein the main tube is made of metallic material, and the seat tube and the chain stays are made of fiber material.

2. The composite bicycle frame as claimed in claim 1, wherein the tubes further comprise a top tube and seat stays, and the top tube and the seat stays are made of fiber material.

3. The composite bicycle frame as claimed in claim 1, wherein the tubes further comprise a head tube made of metallic material.

4. The composite bicycle frame as claimed in claim 1, wherein the tubes further comprise a bottom bracket made of metallic material.

5. The composite bicycle frame as claimed in claim 1, wherein the fiber material is carbon fiber material.

6. The composite bicycle frame as claimed in claim 2, wherein the fiber material is carbon fiber material.

7. The composite bicycle frame as claimed in claim 1, wherein the metallic material is aluminum alloy.

8. The composite bicycle frame as claimed in claim 3, wherein the metallic material is aluminum alloy.

9. The composite bicycle frame as claimed in claim 4, wherein the metallic material is aluminum alloy.

10. The composite bicycle frame as claimed in claim 1, wherein the seat tube has a length and a fiber segment, and the fiber segment has a length longer than a half of the length of the seat tube.

11. The composite bicycle frame as claimed in claim 1, wherein the main tube has a length and a metal segment, and the metal segment has a length longer than a half of the length of the main tube.

12. The composite bicycle frame as claimed in claim 1, wherein the chain stays have a length and a fiber segment, and the fiber segment has a length longer than a half of the length of the chain stays.

13. The composite bicycle frame as claimed in claim 1, wherein the tubes are mutually connected at a plurality joints, and at least one of the joints is a seamless joint.

14. A composite bicycle frame comprising:
a top tube, a seat tube, a head tube, a bottom bracket, a main tube and chain stays and seat stays, wherein
the top tube has a first end and a second end;
the seat tube is connected to the first end of the top tube, has a bottom end, a length and a fiber segment, and the fiber segment has a length longer than a half of the length of the seat tube;
the head tube is connected to the second end of the top tube;
the bottom bracket is connected to the bottom end of the seat tube;
the main tube is connected to the head tube and the bottom bracket, has a length and a metal segment, and the metal segment has a length longer than a half of the length of the main tube;
the chain stays are connected to the seat tube and the bottom bracket, have a length and a fiber segment, and the fiber segment has a length longer than a half of the length of the chain stays; and
the seat stays are connected to the chain stays and the seat tube.

15. The composite bicycle frame as claimed in claim 14, wherein each fiber segment is carbon fiber material.

16. The composite bicycle frame as claimed in claim 14, wherein each metal segment is aluminum alloy.
